(19) United States
(12) Patent Application Publication
(10) Pub. No.: US 2008/0135795 A1
(43) Pub. Date: Jun. 12, 2008

(54) Gas-Controlling Valve For A Sputum Extracting Device

(76) Inventor: George Lee, Taipei (TW)

Correspondence Address: HDSL, 4331 STEVENS BATTLE LANE, FAIRFAX, VA, 22033, US

(21) Appl. No.: 11/567,801

(22) Filed: Dec. 7, 2006

(51) Int. Cl. F16K 1/00

(52) U.S. Cl. 251/321

(57) ABSTRACT

A gas-controlling valve for a sputum extracting device includes a valve stage, an axial rod set, a resilient body and a lid. The valve stage includes an axial sleeve, and the axial sleeve includes an air inlet pipe and an air outlet pipe extended therefrom and communicated to each other. One end of the axial rod set is inserted into the axial sleeve and has operational movement. The axial rod set includes a movable rod and the movable rod includes a through hole radially through the center thereof. The resilient body is arranged in the axial sleeve and both ends of the resilient body abut against corresponding end faces of the valve stage and the axial rod set. The lid covers the valve stage and is corresponding to the axial rod set such that another end of the axial rod set extends out of the lid.

### BACKGROUND OF THE INVENTION

1. Field of the Invention

The present invention relates to a gas-controlling valve, especially to a gas-controlling valve for a sputum extracting device.

2. Description of Prior Art

The conventional gas-controlling valve for sputum extracting device, for example, Taiwan patent No. 533863, comprises a valve stage, an axial rod set, a resilient body and a lid. The valve stage comprises an axial sleeve with an air inlet pipe and an air outlet pipe communicated to each other. One end of the axial rod set passes into the axial sleeve and the axial rod set comprises a movable rod with an annulus groove at center thereof. The resilient body is arranged in the axial sleeve and both ends thereof abut against end faces of the valve stage and the axial rod set. The lid is arranged on the valve stage and corresponding to the axial rod set such that another end of the valve rod extends out of the lid to form the gas-controlling valve for sputum extracting device.

However, the conventional gas-controlling valve for sputum extracting device has following problems during operation. The air flow will be blocked by the movable rod because the movable rod has annulus groove at center thereof. Therefore air flows along the perimeter of the groove and the inner wall of the axial sleeve such that non-smooth flow speed and insufficient absorbing force may occur. The pressure difference between air input pipe and air output pipe cause pressure deviation between meter pressure of the sputum extracting device and actual pressure in the pipe. This imposes difficulty for medical personnel. Moreover, the conventional gas-controlling valve for sputum extracting device has complicated structure and high cost. The conventional gas-controlling valve for sputum extracting device is also not suitable for children user.

### SUMMARY OF THE INVENTION

The present invention is to provide a gas-controlling valve for a sputum extracting device. The gas-controlling valve comprises a through hole radially through the movable rod thereof. Therefore, air flow is not blocked and has smooth flow. There is no pressure difference between the air inlet pipe and the air outlet pipe to simplify operation for medical personnel.

Another, the present invention is to provide a gas-controlling valve for a sputum extracting device, which has compact size and lower cost.

Accordingly, the present invention provides a gas-controlling valve for a sputum extracting device, which includes a valve stage, an axial rod set, a resilient body and a lid. The valve stage includes an axial sleeve, and the axial sleeve includes an air inlet pipe and an air outlet pipe extended therefrom and communicated to each other. One end of the axial rod set is inserted into the axial sleeve and has operational movement. The axial rod set includes a movable rod and the movable rod includes a through hole radially through the center thereof. The resilient body is arranged in the axial sleeve and both ends of the resilient body abut against corresponding end faces of the valve stage and the axial rod set. The lid covers the valve stage and is corresponding to the axial rod set such that another end of the axial rod set extends out of the lid.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the exploded view of the present invention.

FIG. 2 shows the perspective view of the present invention.

FIG. 3 shows the sectional view of the present invention.

FIG. 4 shows the application of the present invention.

FIG. 5 shows another application of the present invention, where the axial rod set is rotated 90 degree.

### DETAILED DESCRIPTION OF THE INVENTION

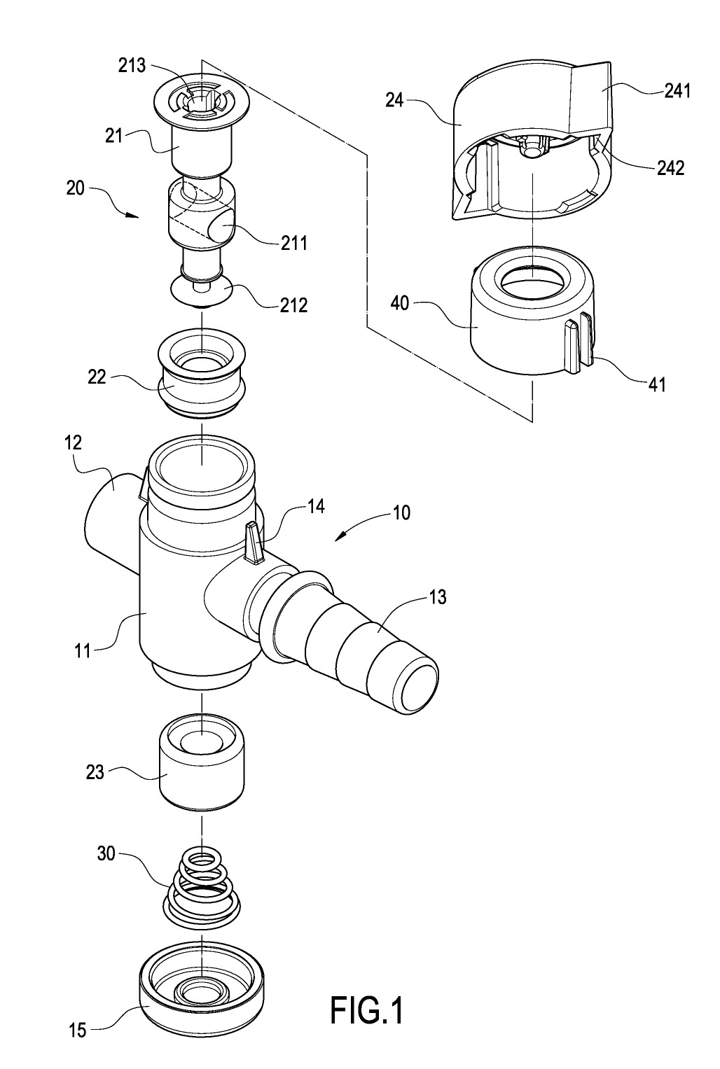

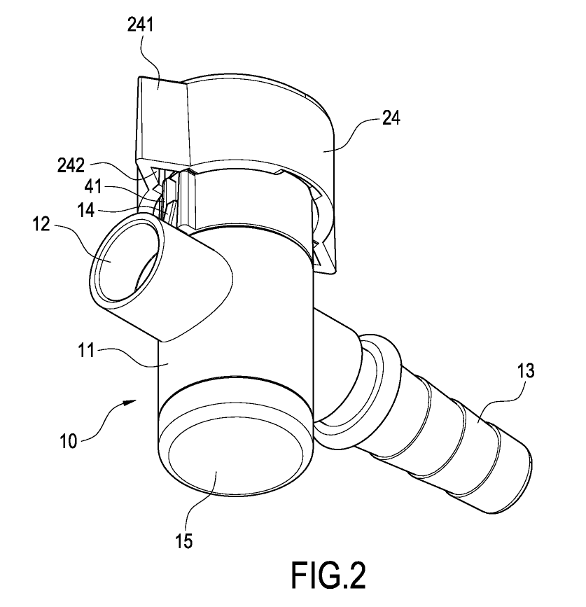

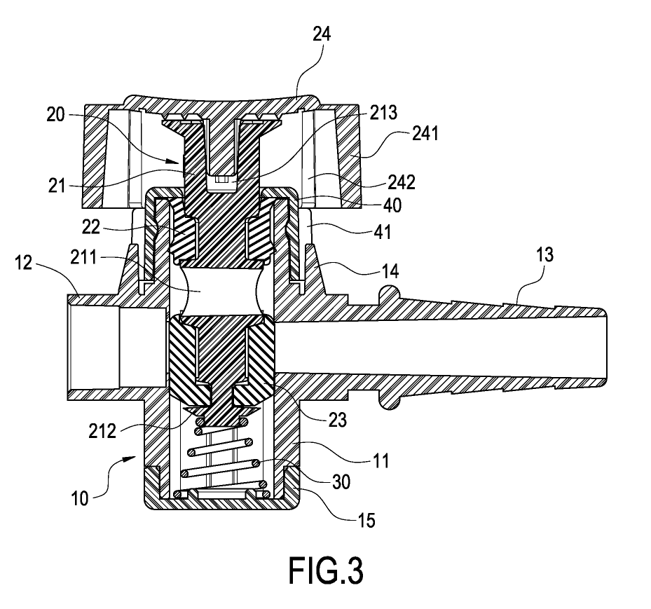

With reference to FIGS. 1 to 3, the present invention provides a gas-controlling valve for sputum extracting device. The gas-controlling valve for sputum extracting device comprises a valve stage 10, an axial rod set 20, a resilient body 30 and a lid 40.

The valve stage 10 comprises a longitudinal axial sleeve 11, which comprises a transverse air inlet pipe 12 and a transverse air outlet pipe 13 on both ends thereof The longitudinal axial sleeve 11 is communicated with the transverse air inlet pipe 12 and the transverse air outlet pipe 13. A clamping block 14 is formed atop the junctions of the longitudinal axial sleeve 11 with the transverse air inlet pipe 12 and the transverse air outlet pipe 13. A bottom cover 15 is provided on the bottom of the longitudinal axial sleeve 11.

One end of the axial rod set 20 enters into the longitudinal axial sleeve 11 of the valve stage 10 and has operative movement with the longitudinal axial sleeve 11. The axial rod set 20 comprises a movable rod 21, an upper ring 22, a lower ring 23 and a button 24. The movable rod 21 comprises a through hole 211 radially through the center thereof. The upper ring 22 and the lower ring 23 are arranged on topside and bottom side of the through hole 211, respectively. The outer surfaces of the upper ring 22 and the lower ring 23 abut the inner wall of the longitudinal axial sleeve 11. The movable rod 21 comprises a cap 212 arranged on bottom side thereof, and a dent 213 arranged on topside thereof and engaged with the button 24. The button 24 comprises two rotational wings 241 corresponding to each other. The rotational wing 241 comprises guiding groove 242 defined therein.

The resilient body 30 can be a conical spiral spring and arranged in the longitudinal axial sleeve 11. The resilient body 30 abuts against inner face of the bottom cover 15 and the end face of the cap 212 on two ends thereof.

The lid 40 is corresponding to the position of the axial rod set 20 and covers the valve stage 10 such that the movable rod 21 extrudes out of the lid 40 and engaged with the button 24. The lid 40 comprises a clamping block 14 corresponding to the valve stage 10 and a clamping plate 41 corresponding to the groove 242 to prevent relative rotation between the lid 40 and the valve stage 10 and to limit the downward movement of the button 24.

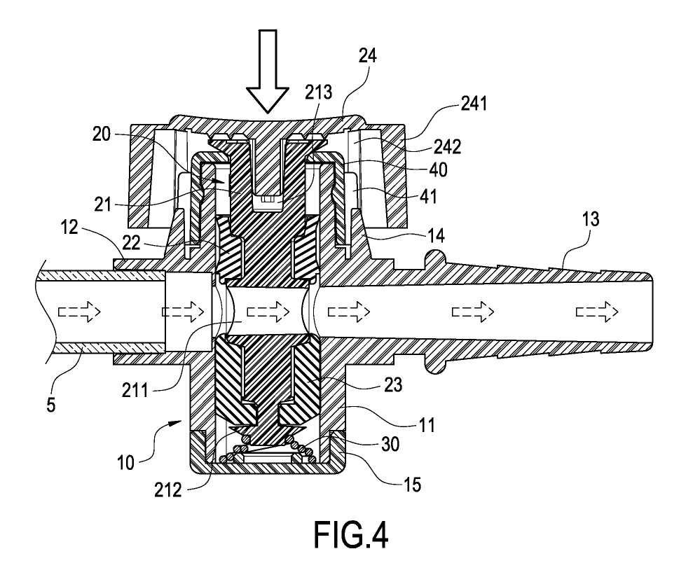

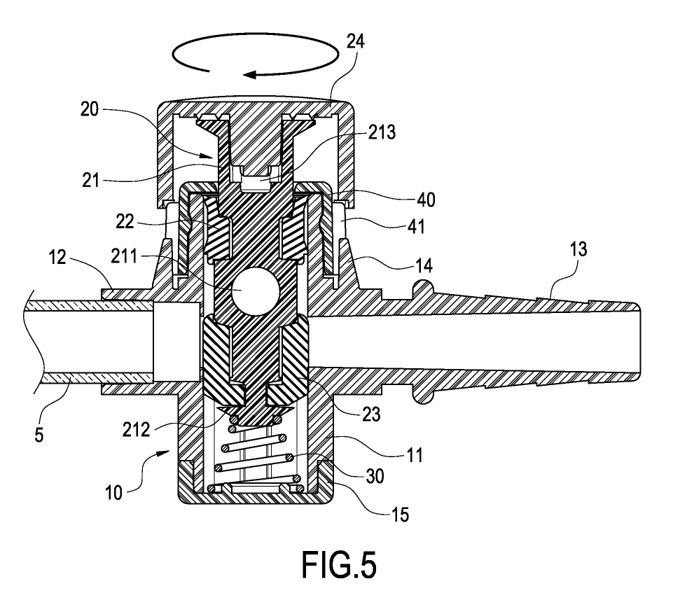

With reference to FIGS. 4 and 5, the gas-controlling valve according to the present invention is connected to a sputum extracting device, where the air inlet pipe 12 and the air outlet pipe 13 are connected to a hose 5 and a negative pressure generator (not shown). During use, the negative pressure generator provides sucking operation and the axial rod set 20 is pressed downward such that the through hole 211 is aimed to center of the air inlet pipe 12 and the air outlet pipe 13. At this time the internal air flows through the through hole 211 of the movable rod 21 and then flows out from the center of the air outlet pipe 13. Therefore, the sputum of patient can be successfully collected.

The axial rod set 20 shown in FIG. 5 has 90-degree rotation and the two rotational wings 241 are vertical to the air inlet pipe 12 and the air outlet pipe 13. The downward movement of the axial rod set 20 is blocked by the clamping plate 41 of the lid 40 and the button 24. Moreover, the rotational wings 241 can be used as indication for flow direction to enhance convenience.

The gas-controlling valve according to the present invention has following advantages. The through hole 211 of the movable rod 21 is radially communicated with center of the movable rod 2, therefore, the air flow is not blocked and smooth. There is no pressure difference for the air inlet pipe 12 and the air outlet pipe 13, and the operation is simplified.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A gas-controlling valve for a sputum extracting device, comprising:
a valve stage comprising an axial sleeve, the axial sleeve comprising an air inlet pipe and an air outlet pipe extended therefrom and communicated to each other;
an axial rod set with one end inserting into the axial sleeve and having operational movement, the axial rod set comprising a movable rod and the movable rod comprising a through hole radially through the center thereof;
a resilient body arranged in the axial sleeve and both ends of the resilient body abutting against corresponding end faces of the valve stage and the axial rod set; and
a lid covering the valve stage and corresponding to the axial rod set such that another end of the axial rod set extends out of the lid.

2. The gas-controlling valve as in claim 1, wherein clamping blocks are provide at the junction of axial sleeve with the air inlet pipe and an air outlet pipe, clamping plates are provide outside the lid for engaging with the clamping blocks.

3. The gas-controlling valve as in claim 2, wherein the axial rod set comprises a button, the movable rod comprises a dent arranged on top thereof and engaged with the button.

4. The gas-controlling valve as in claim 3, wherein two rotational wings are formed outside the button and comprise guiding grooves therein, the guiding grooves are corresponding to the clamping plates to limit downward movement of the button.

5. The gas-controlling valve as in claim 1, wherein the axial rod set further comprises an upper ring and a lower ring, which are fit to upper and lower sides of the through hole.

6. The gas-controlling valve as in claim 1, wherein the resilient body is a spiral spring.

7. The gas-controlling valve as in claim 6, wherein the axial sleeve comprises a bottom cover on bottom thereof, the movable rod comprises a cap on bottom thereof, both ends of the resilient body abut to the bottom cover and the cap.
